(19) United States
(12) Patent Application Publication
(10) Pub. No.: US 2023/0281461 A1
(43) Pub. Date: Sep. 7, 2023

(54) APPARATUS AND METHOD FOR DETECTING DEEPFAKE BASED ON CONVOLUTIONAL LONG SHORT-TERM MEMORY NETWORK

(71) Applicant: RESEARCH & BUSINESS FOUNDATION SUNGKYUNKWAN UNIVERSITY, Suwon-si (KR)

(72) Inventors: Simon Sungil WOO, Suwon-si (KR); Sang Yup LEE, Suwon-si (KR); Shahroz TARIQ, Suwon-si (KR)

(73) Assignee: RESEARCH & BUSINESS FOUNDATION SUNGKYUNKWAN UNIVERSITY, Suwon-si (KR)

(21) Appl. No.: 18/114,416

(22) Filed: Feb. 27, 2023

(30) Foreign Application Priority Data
Mar. 4, 2022 (KR) 10-2022-0027876

(51) Int. Cl. G06N 3/096; G06N 3/0442

(52) U.S. Cl. CPC G06N 3/096; G06N 3/0442

(57) ABSTRACT

The present specification relates to an apparatus and a method for detecting a deepfake based on a convolutional long short-term memory network. The method of detecting a deepfake includes receiving, by an input unit, a plurality of training datasets selected from a plurality of domains; training, by a learning unit, a deepfake detection model based on the training datasets; and detecting, by a detection unit, whether a deepfake is present from the test datasets using the trained deepfake detection model. The training of the deepfake detection model includes sequentially training the deepfake detection model through initial learning using training datasets of a specific domain among the plurality of domains and transfer learning using training datasets of domains other than the specific domain.

### CROSS-REFERENCE TO RELATED APPLICATIONS

This application claims the priority benefit of Korean Patent Application No. 10-2022-0027876 filed on Mar. 4, 2022 in the Korean Intellectual Property Office, the disclosures of which are incorporated herein by reference.

### BACKGROUND

### 1. Field

The present specification relates to an apparatus and method for detecting a deepfake based on a convolutional long short-term memory network.

### 2. Description of the Related Art

A deepfake refers to a fake image obtained by synthesizing two people's faces. There are various generation techniques for deepfakes, such as a facial reenactment that copies only a person's facial expression and an identity swap that replaces one person's face with another person's face, creation of such deepfakes is very easy due to being constructed with open-source software, and very different characteristics exhibit for each generation technique.

Although a large number of deep-learning-based detection methods have been proposed to identify a specific type of deepfake, the conventional deepfake detection models have difficulty in detecting various deepfakes at once.

In addition, the conventional deepfake detection techniques require a large number of images generated by the same deepfake generation technique in order to achieve high detection performance. However, when a new type of deepfake appears, the deepfake is not easily detected due to lack of a large amount of image data for the deepfake, and the accuracy of detection is very low.

In addition, the conventional deepfake detection techniques divide video data in units of frames and perform analysis on each frame, and thus it is difficult to analyze a change in a deepfake face over time in video data.

### SUMMARY

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter.

The present specification is directed to providing an apparatus and method for detecting a deepfake that are capable of detecting a deepfake with high accuracy even for a dataset of an unlearned new domain using only Convolutional LSTM based Residual Network.

In addition, the present specification is directed to providing an apparatus and method for detecting a deepfake that are capable of efficiently performing learning by performing transfer learning using only a very small amount of datasets.

In addition, the present specification is directed to providing an apparatus and method for detecting a deepfake that are capable of analyzing a change in a deepfake face over time by analyzing a change pattern between consecutive frames.

The objects of the present specification are not limited to the objects mentioned above, and other objects and advantages of the present specification that are not mentioned may be understood by the following description, and will be more clearly understood by the embodiments of the present specification. It will also be readily apparent that the objects and advantages of the present specification may be realized by the means and combinations thereof indicated in the appended claims.

According to an aspect of the present invention, there is provided a method of detecting a deepfake, the method including: receiving, by an input unit, a plurality of training datasets selected from a plurality of domains; training, by a learning unit, a deepfake detection model based on the training datasets; receiving, by the input unit, a test dataset by which a deepfake is to be actually detected; and detecting, by a detection unit, whether a deepfake is present from the test datasets using the trained deepfake detection model.

The training of the deepfake detection model may include sequentially training the deepfake detection model through initial learning using training datasets of a specific domain among the plurality of domains and transfer learning using training datasets of domains other than the specific domain.

The training of the deepfake detection model may include using the initial learning and the transfer learning to train the deepfake detection model to distinguish a real face and a fake face.

The training of the deepfake detection model may include setting the training datasets as input data and setting the real face or the fake face as output data to train the deepfake detection model.

The training of the deepfake detection model may further include performing preprocessing on the training datasets using a data augmentation method before performing the initial learning.

The data augmentation method may adjust at least one of a brightness, a contrast, a picture flip, or a picture angle to expand the dataset.

The training of the deepfake detection model may include, when performing the initial learning, freezing network weights of a previously set block such that half of weights of the deepfake detection model may be prevented from being changed, to maintain the initially learned datasets.

The test dataset may be a DeepFake in the Wild (DFW) domain dataset that may not be included in the training datasets.

According to an aspect of the present invention, there is provided an apparatus for detecting a deepfake, the apparatus including: an input unit configured to receive a plurality of training datasets selected from a plurality of domains and receive a test dataset by which a deepfake is to be actually detected; a learning unit configured to train a deepfake detection model based on the training datasets; and a detection unit configured to detect whether a deepfake is present from the test datasets using the trained deepfake detection model.

The learning unit may be configured to sequentially train the deepfake detection model through initial learning using training datasets of a specific domain among the plurality of domains and transfer learning using training datasets of domains other than the specific domain.

The learning unit may be configured to use the initial learning and the transfer learning to train the deepfake detection model to distinguish a real face and a fake face.

The learning unit may be configured to set the training datasets as input data and set the real face or the fake face as output data to train the deepfake detection model.

The transfer learning may be performed using a smaller number of training datasets than the number of training datasets used for the initial learning.

The learning unit may be configured to perform preprocessing on the training datasets using a data augmentation method before performing the initial learning.

The data augmentation method may adjust at least one of a brightness, a contrast, a picture flip, or a picture angle to expand the dataset.

The learning unit may be configured to, when performing the initial learning, freeze network weights for a previously set block such that half of weights of the deepfake detection model may be prevented from being changed, to maintain the initially learned training datasets.

The plurality of domains may include at least one of DeepFakes (DF), Deepfake Detection (DFD), Face2Face (F2F), or NeuralTextures (NT), and each of the training datasets may be composed of a plurality of consecutive frames.

The deepfake detection model may include a plurality of blocks, and each of the plurality of blocks may include at least one of a convolution long short-term memory layer (ConvLSTM 2D), a batch normalization layer (BN), a ReLU layer (R), a dropout layer (D), a global average pooling layer (Global AvgPool 3D), or a fully connected layer (Dense(2)).

The plurality of blocks may be connected to each other by a residual connection (Add).

The test dataset may be a DFW domain dataset that is not included in the training datasets.

### BRIEF DESCRIPTION OF THE DRAWINGS

These and/or other aspects of the disclosure will become apparent and more readily appreciated from the following description of the embodiments, taken in conjunction with the accompanying drawings of which:

The above and other objects, features and advantages of the present invention will become more apparent to those of ordinary skill in the art by describing exemplary embodiments thereof in detail with reference to the accompanying drawings, in which:

FIG. 1 is a block diagram illustrating an apparatus for detecting a deepfake according to an embodiment of the present specification;

FIG. 2 is a diagram illustrating deepfake generation results through generation techniques of various domains;

FIG. 3 shows diagrams illustrating consecutive frames of a real video and consecutive frames of a deepfake video according to an embodiment of the present specification;

FIG. 4 is a flowchart showing the operation of an apparatus for detecting a deepfake according to an embodiment of the present specification;

FIGS. 5 to 7 are architecture diagrams illustrating the structure of a CLRNet according to an embodiment of the present specification;

FIGS. 8A to 8F are diagrams illustrating activation maps by domains when the apparatus for detecting a deepfake according to the present specification detects a test dataset using a CLRNet;

FIG. 9 is a table showing the performance comparison of transfer learning and merge learning according to the present specification;

FIG. 10 is a table showing the performance comparison of a Convolutional LSTM based Residual Network. (CLRNet) according to the present specification and a conventional deepfake detection model in an open domain performance evaluation test; and

FIG. 11 is a flowchart showing a method of detecting a deepfake according to an embodiment of the present specification.

Throughout the drawings and the detailed description, the same reference numerals may refer to the same, or like, elements. The drawings may not be to scale, and the relative size, proportions, and depiction of elements in the drawings may be exaggerated for clarity, illustration, and convenience.

### DETAILED DESCRIPTION

While embodiments according to the concept of the present invention are subject to various modifications and alternative forms, specific embodiments thereof are shown by way of example in the accompanying drawings and will herein be described in detail. However, it should be understood that there is no intent to limit the present invention to the particular forms disclosed, rather the present invention is to cover all modifications, equivalents, and alternatives falling within the spirit and scope of the present invention. In the drawings, like numerals refer to like elements while describing each figure.

It will be understood that, although the terms “first,” “second,” “A,” “B,” etc. may be used herein to describe various elements, these elements should not be limited by these terms. These terms are only used to distinguish one element from another. For example, a first element could be named a second element, and, similarly, a second element could be named a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is for the purpose of only describing particular embodiments and is not intended to limit the invention. As used herein, the singular forms “a” and “an” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by those of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present invention will be described in detail with reference to the accompanying drawings.

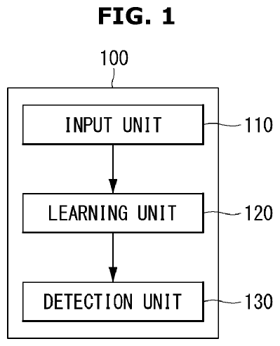

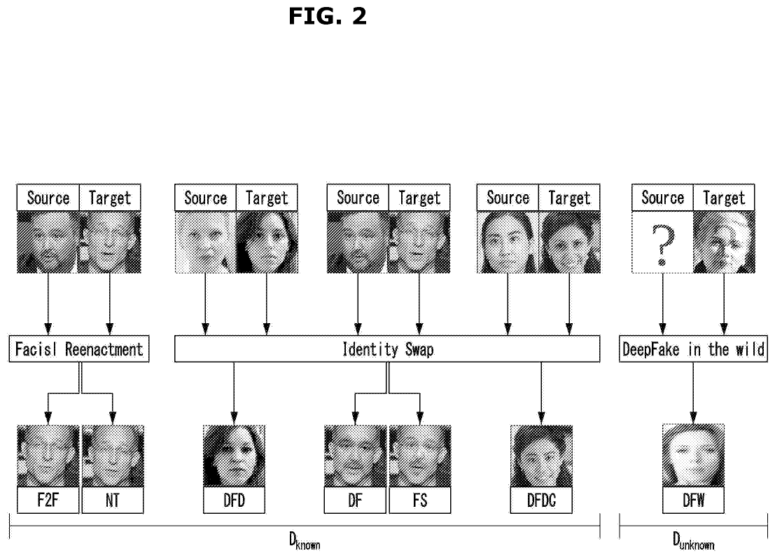

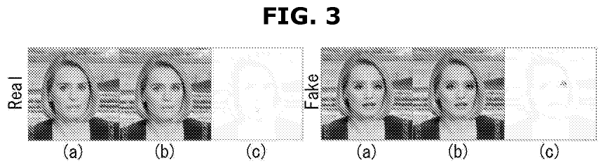

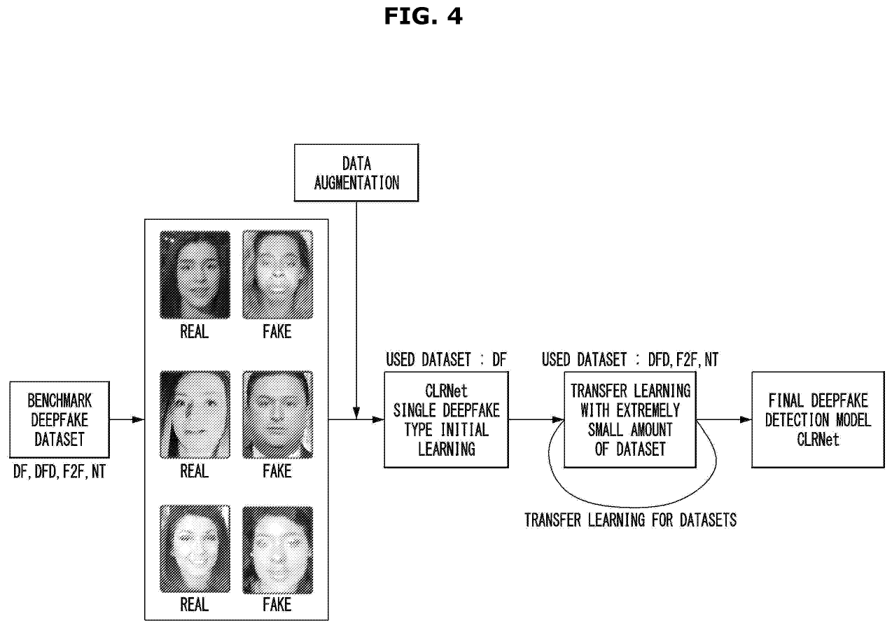

FIG. 1 is a block diagram illustrating an apparatus for detecting a deepfake according to an embodiment of the present specification, FIG. 2 is a diagram illustrating deepfake generation results through generation techniques of various domains, FIG. 3 is a diagram illustrating consecutive frames of a real video and consecutive frames of a deepfake video according to an embodiment of the present specification, and FIG. 4 is a flowchart showing the operation of an apparatus for detecting a deepfake according to an embodiment of the present specification.

An apparatus 100 for detecting a deepfake is an apparatus for detecting whether a specific video is a deepfake video using a Convolutional LSTM based Residual Network (CLRNet), which is a deepfake detection model, and includes an input unit 110, a learning unit 120, and a detection unit 130.

Referring to FIG. 2, deepfake generation results obtained using deepfake datasets of seven domains are illustrated.

As shown in FIG. 2, FaceSwap (FS) is a computer graphics-based method that transfers a face region from a source to a target video, Face2Face (F2F) is a face reproduction method that transfers a facial expression of a source image to a target image while maintaining the identity of a subject, and NeuralTextures (NT) is a method used to identify a subject's neural texture using source video data including a rendering network, in which only the facial expression corresponding to the mouth region is modified and the eye region is not changed.

In addition, Deepfake Detection (DFD) dataset consists of 363 real and 3,000 deepfakes of 28 actors. Every person has been given tasks, such as walking while using various expression such happy or angry. A variety of off-the-shelf face swap methods are applied to build this dataset.

Deepfake detection challenge (DFDC) is one of the extensive deepfake datasets, and includes 100,000 images of different qualities, viewing, lighting and scenes.

DeepFake in the Wild (DFW) corresponds to most of the current deepfake videos on the Internet, in which deepfakes are generated using a celebrity's face or replaced with another celebrity using a movie character.

In the facial reenactment methods, such as F2F and NT, the source is used to drive a facial expression, a gaze, a mouth, and a pose of the target, and in the identity swap methods, such as DF, FS, DFD, and DFDC, a part or the entirety of a surface of the target is swapped with that of a source while preserving the identity of the target.

In addition, DFWs may be generated using a large number of existing deepfake generation methods, which makes sources and targets very difficult to find and further complicates analysis and detection.

That is, the apparatus 100 for detecting a deepfake may generate a deepfake image in which a facial expression or face of a target image is replaced with a facial expression or face of a source image.

In this case, six domains, that is, F2F (University of Munich Benchmark Open Source Dataset), NT (University of Munich Benchmark Open Source Dataset), DFD (Google Benchmark Open Source Dataset), DF (University of Munich Benchmark Open Source Dataset), and FS (University of Munich Benchmark Open Source Dataset) among the seven domains represent open source datasets whose generation techniques are already known, as shown in Equation 1 below, and DFW represents datasets whose generation technique is unknown, as shown in Equation 2 below.

[symbol]

_{known}={DF,FS,F2F,NT,DFD} [Equation 1]

[symbol]

_{unknown}={DFW} [Equation 2]

In this case, the training datasets are some selected datasets among datasets included in a domain.

The input unit 110 receives a plurality of training datasets selected from a plurality of domains.

Specifically, the training datasets may each be composed of a plurality of consecutive frames as shown in FIG. 3. In FIG. 3, pictures on the left side represent consecutive frames of a real video, and pictures on the right side represent consecutive frames of a deepfake video. In comparison with the real video with little difference between frames, the deepfake video has an unnatural difference between frames depending on the brightness of the face region or the size of the eyes and lips in a frame to which a deepfake is applied.

FIG. 3A indicates an n^{th} frame, FIG. 3B indicates an n+1^{th} frame, and FIG. 3C indicates an n+2^{th} frame. In FIG. 3C, the difference between frames of the deepfake video are displayed as red dots. Such a difference between consecutive fames may be extracted through a convolutional long short-term memory (LSTM) cell to be described below.

That is, the apparatus for detecting a deepfake according to the present specification may detect deepfakes using consecutive frames as a training dataset rather than using a single frame, thereby analyzing a change in a deepfake face over time, and also may consider spatial information within a single frame as well as time information between consecutive frames, thereby more precisely detecting deepfake frames. In this case, the plurality of consecutive frames may be five frames.

The learning unit 120 trains a convolutional LSTM-based residual network (CLRNet), which is a deepfake detection model, based on the training datasets.

In this case, the learning unit 120 may determine whether a face in frames is a real face without synthesis or a deepfake face that is fake through the deepfake detection model.

Specifically, the learning unit 120 sequentially trains the CLRNet through initial learning using training datasets of a specific domain among the plurality of domains and transfer learning using training datasets of domains other than the specific domain.

Referring to FIG. 4, the input unit 110 receives a plurality of training datasets from a plurality of domains DF, DFD, F2F, and NT, and labels each frame of each training dataset as real or fake.

The learning unit 120 performs initial learning (single domain learning) on a CLRNet using DF, which is one of the plurality of domains. In this case, the learning unit 120 performs initial learning using a large amount of training datasets (e.g., 30,000 frames) in the DF domain.

The learning unit 120 may pre-process the training datasets through data augmentation before performing the initial learning. The data augmentation is a method of expanding a dataset by adjusting a brightness, a contrast, a picture flip, and a picture angle while retaining the key features of the dataset, and applying the data augmentation method to the training datasets may prevent overfitting of the CLRNet and improve generalization performance.

That is, the learning unit 120 performs the initial learning on the CLRNet using a single deepfake type.

Then, the learning unit 120 performs transfer learning. Transfer learning refers to using some of the abilities of a neural network trained in a specific field for training a neural network used in a similar or completely new field. That is, the learning unit 120 completely trains the CLRNet using the DF datasets, and then performs transfer learning on each of the domains DFD, F2F, and NT except for the domain DF having been used for the initial learning.

For example, ten image samples from each of the remaining training datasets may be extracted as target datasets, and targets may be learned through transfer learning.

However, it is not necessary to use only DF data for the initial learning on the CLRNet and any single domain randomly selected from among the plurality of domains may be used for the initial learning. In addition, according to experimental results, the CLRNet may be provided with high performance when transfer learning is performed in the order of FS, DF, DFD, F2F, and NT after initial learning.

That is, the learning unit 120 performs transfer learning on the CLRNet, for which the initial learning has been completed, using a very small amount of new type of deepfakes.

Then, the learning unit 120, after performing the transfer learning on all the datasets, derives a CLRNet, which is the final deepfake detection model, and the derived CLRNet is used for various deepfake detections.

Meanwhile, transfer learning is performed using a smaller number of training datasets than the number of training datasets used for initial learning. For example, the learning unit 120 may perform the learning using eighty frames for each domain, which is a very small amount compared to the training datasets used in the initial learning, and by performing learning on the CLRNet using a small number of training datasets, the learning unit 120 may efficiently train the CLRNet.

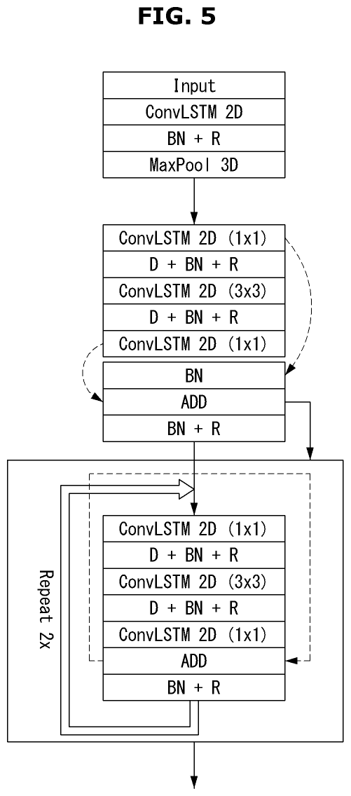

In addition, when performing initial learning, the learning unit 120 performs freezing to prevent half of the weights of the CLRNet from being changed to prevent performance degradation for the initially learned deepfakes. Specifically, in a network structure of the CLRNet, which will be described below with reference to FIG. 5, network weights are frozen for the first half blocks to maintain the initially learned training datasets and prevent degradation in learning performance.

Through the method, the learning unit 120 may efficiently train the CLRNet without performance degradation while using a small number of training datasets.

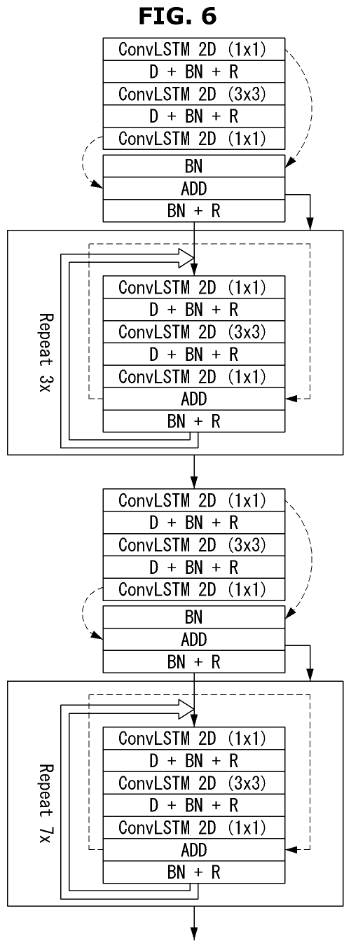

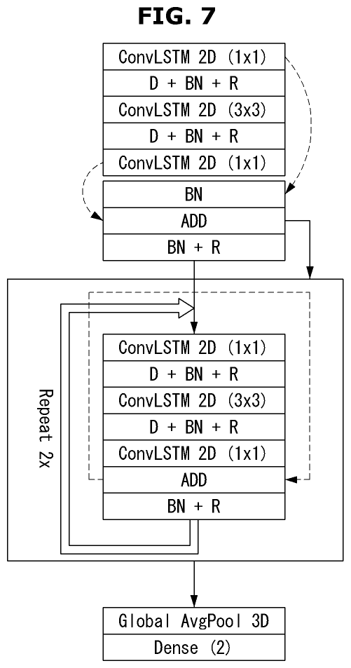

FIGS. 5 to 7 are architecture diagrams illustrating the structure of a CLRNet according to an embodiment of the present specification. Hereinafter, the apparatus for detecting a deepfake will be described with reference to FIGS. 5 to 7.

Referring to FIGS. 5 to 7, the CLRNet includes a plurality of blocks, and each of the plurality of blocks includes at least one of a convolutional long short-term memory layer ConvLSTM 2D, a batch normalization layer BN, a ReLU layer R, a dropout layer D, and a global average pooling layer Global AvgPool 3D, or a fully connected layer Dense(2).

The apparatus 100 for detecting a deepfake requires a model capable of detecting temporal information, such as an LSTM, and a model capable of detecting spatial information, such as a convolution neural network (CNN), in order to detect a difference between a deepfake image and a real image within a single frame and a discrepancy between consecutive frames.

The ConvLSTM 2D of the CLRNet is a layer using multiple convolutional LSTM cells and may detect temporal information and spatial information in frames of a training dataset.

On the other hand, in order to process many types of datasets, such as deepfakes, with a single model, it is preferable to use a model have a great depth and a great size such that training datasets of all domains are learned.

Therefore, the apparatus 100 for detecting a deepfake according to the present specification repeatedly overlaps the convLSTM 2D and the dropout layer D+the batch normalization layer BN+the ReLU layer R to deepen the depth.

In addition, the apparatus 100 for detecting a deepfake may connect the plurality of blocks to each other through a residual connection as shown by the dotted arrow, thereby preventing a gradient vanishing problem that occurs as the depth increases.

The apparatus 100 for detecting a deepfake may be trained to output a classification result of real or fake in response to a sequence of consecutive images being input.

Referring back to FIG. 1, the detection unit 130 detects whether a deepfake is present from a test dataset using the trained CLRNet. In this case, the test dataset may be a dataset for testing whether the trained CLRNet has been properly trained and the level of the deepfake detection performance of the trained CLRNet, and the test dataset may be the same as the training dataset used for training or may be a dataset of a different domain from that of the training dataset used for training. The dataset of a different domain from that of the training dataset may be, for example, a dataset of a DFW domain, which is an open-domain.

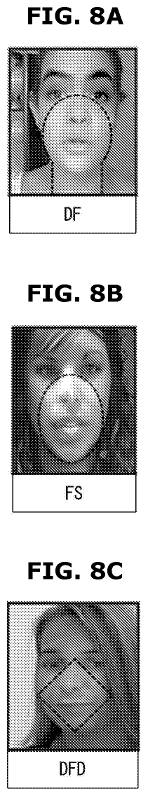

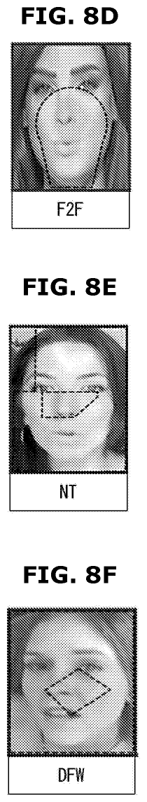

FIGS. 8A to 8F are diagrams illustrating activation maps by domains when the apparatus for detecting a deepfake according to the present specification detects a test dataset using a CLRNet.

Referring to the diagrams, it can be seen that the apparatus 100 for detecting a deepfake is intensively activated in the center of the face (near the nose) in the case of the DF domain of FIG. 8A, the FS domain of FIG. 8B, the DFD domain of FIG. 8C, and the F2F domain of FIG. 8D, and is randomly activated around the face in the case of the NT domain of FIG. 8E, but is evenly activated in most regions of the face in the case of the DFW domain of FIG. 8F.

In more detail, in FIGS. 8A to 8D, activation occurs in a region inside a figure indicated by a dotted line in the central region, intensively occurs at the nose, which is the center of the face, and the closer to the dotted line, the lower the activity.

In addition, in FIG. 8E, activation occurs in a region other than the inside of a polygon indicated by a dotted line in the central part, intensively occurs in the regions of the eyes, cheeks, and mouth close to the dotted line, and the activity is lowered in the upper center of the forehead and the right shoulder, that is, the edge region.

In addition, in FIG. 8F, activation occurs in a region other than the inside of a quadrangle indicated by a dotted line in the central region, intensively occurs in the regions of the cheeks and mouth close to the dotted line, and the closer to the edge, the lower the activity.

It can be seen that the apparatus 100 for detecting a deepfake may accurately detect a deepfake even for a dataset of a DFW domain whose generation technique is unknown.

The detection unit 130 determines whether all the frames included in the test datasets are a real video without deepfake synthesis or are a synthesized deepfake video, and outputs a determination result. The CLRNet outputs the result as 0 or 1 as a binary classification.

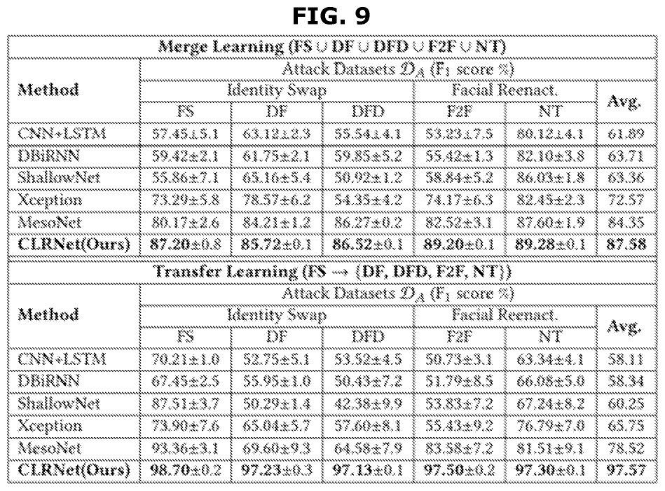

FIG. 9 is a table showing the performance comparison of transfer learning and merge learning according to the present specification.

Unlike transfer learning, in which learning is performed using training datasets of domains other than training datasets of a domain having been used for initial learning, merge learning integrates all training datasets to perform learning at one time.

Referring to the table, it can be seen that the CLRNet according to the present specification shows higher performance than other deepfake detection models in both transfer learning and merge learning. In particular, the average performance in transfer learning is 97.57%, which is about 10% higher than the performance of 87.58% in merge learning.

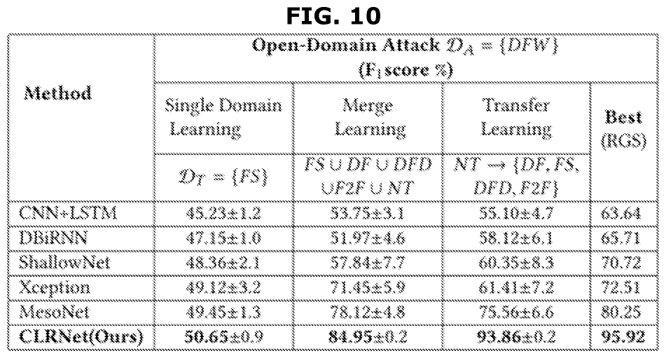

FIG. 10 is a table showing the performance comparison of a CLRNet according to the present specification and a conventional deepfake detection model in an open domain performance evaluation test.

The open-domain performance evaluation test (an open-domain attack) is a test that detects the performance of a deepfake detection model using a test dataset whose generation technique is unknown. It can be seen that the CLRNet has the highest performance, i.e., has 50.65%, 84.95%, and 93.86% in single domain learning, merge learning, and transfer learning, respectively.

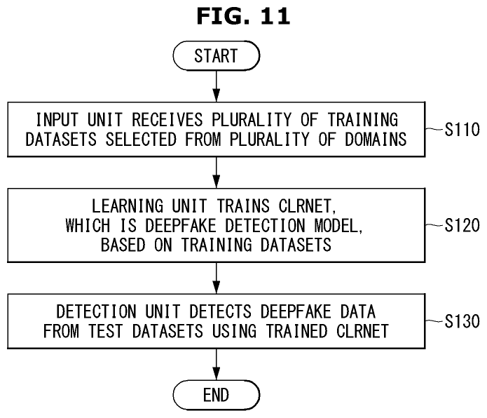

FIG. 11 is a flowchart showing a method of detecting a deepfake according to an embodiment of the present specification.

Referring to FIG. 11, a method of detecting a deepfake includes receiving, by the input unit, a plurality of training datasets selected from a plurality of domains (S110).

In addition, the method includes training, by the learning unit, a CLRNet, which is a deepfake detection model, based on the training datasets (S120). In this case, the learning unit may sequentially train the CLRNet through initial learning using training datasets of a specific domain among the plurality of domains and transfer learning using training datasets of domains other than the specific domain.

Finally, the method may include detecting, by the detection unit, deepfakes from a test dataset using the trained CLRNet (S130).

As is apparent from the above, an apparatus and method for detecting a deepfake according to an embodiment of the present specification can detect a deepfake with high accuracy even for a dataset of an unlearned new domain using only a single CLRNet model.

In addition, an apparatus and method for detecting a deepfake according to an embodiment of the present specification can efficiently perform learning by performing transfer learning using only a very small amount of datasets.

In addition, an apparatus and method for detecting a deepfake according to an embodiment of the present specification can analyze a change in a deepfake face over time by analyzing a change pattern between consecutive frames.

As described above, the present invention has been described with reference to the illustrated drawings, but the present invention is not limited by embodiments and drawings disclosed in this specification, and various modifications can be obtained by those skilled in the art within the scope of the technical spirit of the present invention. In addition, although the operation effects according to the configuration of the present invention have not been explicitly described while describing the embodiments of the present invention, the effects predictable by the configuration should also be recognized.

What is claimed is:

1. A method of detecting a deepfake, the method comprising:
receiving, by an input unit, a plurality of training datasets selected from a plurality of domains;
training, by a learning unit, a deepfake detection model based on the training datasets;
receiving, by the input unit, a test dataset by which a deepfake is to be actually detected; and
detecting, by a detection unit, whether a deepfake is present from the test datasets using the trained deepfake detection model.

2. The method of claim 1, wherein the training of the deepfake detection model includes sequentially training the deepfake detection model through initial learning using training datasets of a specific domain among the plurality of domains and transfer learning using training datasets of domains other than the specific domain.

3. The method of claim 2, wherein the training of the deepfake detection model includes using the initial learning and the transfer learning to train the deepfake detection model to distinguish a real face and a fake face.

4. The method of claim 3, wherein the training of the deepfake detection model includes setting the training datasets as input data and setting the real face or the fake face as output data to train the deepfake detection model.

5. The method of claim 2, wherein the training of the deepfake detection model further includes performing preprocessing on the training datasets using a data augmentation method before performing the initial learning.

6. The method of claim 5, wherein the data augmentation method adjusts at least one of a brightness, a contrast, a picture flip, or a picture angle to expand the dataset.

7. The method of claim 2, wherein the training of the deepfake detection model includes, when performing the initial learning, freezing network weights of a previously set block such that half of weights of the deepfake detection model are prevented from being changed, to maintain the initially learned training datasets.

8. The method of claim 1, wherein the test dataset is a DeepFake in the Wild (DRW) domain dataset that is not included in the training datasets.

9. An apparatus for detecting a deepfake, the apparatus comprising:
an input unit configured to receive a plurality of training datasets selected from a plurality of domains and receive a test dataset by which a deepfake is to be actually detected;
a learning unit configured to train a deepfake detection model based on the training datasets; and
a detection unit configured to detect whether a deepfake is present from the test datasets using the trained deepfake detection model.

10. The apparatus of claim 9, wherein the learning unit is configured to sequentially train the deepfake detection model through initial learning using training datasets of a specific domain among the plurality of domains and transfer learning using training datasets of domains other than the specific domain.

11. The apparatus of claim 10, wherein the learning unit is configured to use the initial learning and the transfer learning to train the deepfake detection model to distinguish a real face and a fake face.

12. The apparatus of claim 11, wherein the learning unit is configured to set the training datasets as input data and set the real face or the fake face as output data to train the deepfake detection model.

13. The apparatus of claim 11, wherein the transfer learning is performed using a smaller number of training datasets than the number of training datasets used for the initial learning.

14. The apparatus of claim 11, wherein the learning unit is configured to perform preprocessing on the training datasets using a data augmentation method before performing the initial learning.

15. The apparatus of claim 14, wherein the data augmentation method adjusts at least one of a brightness, a contrast, a picture flip, or a picture angle to expand the dataset.

16. The apparatus of claim 11, wherein the learning unit is configured to, when performing the initial learning, freeze network weights for a previously set block such that half of weights of the deepfake detection model are prevented from being changed, to maintain the initially learned training datasets.

17. The apparatus of claim 9, wherein the plurality of domains includes at least one of DeepFakes (DF), Deepfake Detection (DFD), Face2Face (F2F), or NeuralTextures (NT), and each of the training datasets is composed of a plurality of consecutive frames.

18. The apparatus of claim 9, wherein the deepfake detection model includes a plurality of blocks, and
each of the plurality of blocks includes at least one of a convolution long short-term memory layer (ConvLSTM 2D), a batch normalization layer (BN), a ReLU layer (R), a dropout layer (D, a global average pooling layer (Global AvgPool 3D), or a fully connected layer (Dense(2)).

19. The apparatus of claim 18, wherein the plurality of blocks are connected to each other by a residual connection (Add).

20. The apparatus of claim 9, wherein the test dataset is a DeepFake in the Wild (DFW) domain dataset that is not included in the training datasets.
